(19) United States
(12) Patent Application Publication
(10) Pub. No.: US 2021/0305926 A1
(43) Pub. Date: Sep. 30, 2021

(54) ROTATIONAL ELECTRIC MACHINE, DRIVE CONTROL SYSTEM, AND POWER GENERATION METHOD

(71) Applicant: EXEDY Corporation, Osaka (JP)

(72) Inventors: Kohsuke MURATA, Osaka (JP); Kenji KITADA, Osaka (JP)

(73) Assignee: Exedy Corporation

(21) Appl. No.: 17/189,661

(22) Filed: Mar. 2, 2021

(30) Foreign Application Priority Data
Mar. 30, 2020 (JP) 2020-060721

(51) Int. Cl. H02P 9/48; B60L 15/20

(52) U.S. Cl. CPC H02P 9/48; H02P 2101/45; B60L 15/2045

(57) ABSTRACT

A rotational electric machine includes: a stator configured to generate a rotating magnetic field by an alternating current converted from a power supply voltage of a battery; a rotor configured to rotate by the rotating magnetic field; a field coil configured to excite the rotor by a direct current converted from a power supply voltage of the battery; an acquisition unit configured to acquire the power supply voltage and an induced voltage of the rotational electric machine; and a power generation control unit configured to perform regenerative power generation when the induced voltage acquired is lower than a preset voltage equal to or lower than the power supply voltage acquired, and to perform alternator power generation by the induced voltage when the induced voltage acquired is equal to or higher than the preset voltage.

### CROSS-REFERENCE TO RELATED APPLICATION

This application claims the benefit of Japanese Patent Application No. 2020-060721, filed Mar. 30, 2020.

### FIELD OF THE INVENTION

The present invention relates to a rotational electric machine, a drive control system of a vehicle, and a method for controlling the rotational electric machine.

### DESCRIPTION OF THE RELATED ART

Patent Document 1 discloses a rotational electric machine including a field coil.

### PRIOR ART DOCUMENTS

### Patent Document

Patent Document 1: JP 2016-105696 A

### SUMMARY OF THE INVENTION

In some cases, a rotational electric machine including a field coil, such as the above-described rotational electric machine, operates as a generator, Ira this case, depending on the rotational speed of the rotational electric machine, the induced voltage of the rotational electric machine may become higher than the power supply voltage, and regenerative power generation may not be possible.

An object of the present invention is to provide a rotational electric machine capable of generating power even when regenerative power generation cannot be performed, drive control system including be rotational electric machine, and a method for controlling the rotational electric machine.

In order to achieve the object, the present invention is configured as follows.

A first aspect of the present invention provides a rotational electric machine connected to a battery, the rotational electric machine including:

a stator configured to generate a rotating magnetic field by an alternating current co from a power supply voltage of the battery;

a rotor configured to rotate by the rotating magnetic field;

a field coil configured to excite the rotor by a direct current converted from a power supply voltage of the battery;

an acquisition unit configured to acquire the power supply voltage and an induced voltage of the rotational electric machine; and

a power generation control unit configured to perform regenerative power generation when the acquired induced voltage is lower than a preset voltage equal to or lower than the acquired power supply voltage, and to perform alternator power generation by the induced Volta_{g}e when the acquired induced voltage is equal to or higher than the preset voltage.

A second aspect of the present invention provides a drive control system of a vehicle including a battery and a rotational electric machine connected to the battery, wherein

the rotational electric machine includes

a stator configured to generate a rotating magnetic field by an alternating current converted from a power supply voltage of the battery,

a rotor configured to rotate by the rotating magnetic field,

a field coil configured to excite the rotor by

a direct current converted from a power supply voltage of the battery, and

an acquisition unit configured to acquire the power supply voltage and an induced voltage of the rotational electric machine, and

the drive control system of a vehicle further including a power generation control unit configured to perform regenerative power generation by kinetic energy Of the vehicle when the acquired induced voltage is lower than a preset voltage equal to or lower than the acquired power supply voltage, and to perform alternator power generation by the induced voltage when the acquired induced voltage is equal to or higher than the preset voltage

A third aspect of the present invention provides a power generation method of a rotational electric machine connected to a battery, the rotational electric machine including, a stator configured to generate a rotating magnetic field by an alternating current converted from a power supply voltage of the battery, a rotor configured to rotate by the rotating magnetic field, and a field coil configured to excite the rotor by a direct current converted from a power supply voltage of the battery,

the power generation method including:

acquiring a power supply voltage of the battery and an induced voltage of a rotational electric machine; and

performing regenerative power generation when the acquired induced voltage is lower than a preset voltage equal to or lower than the acquired power supply voltage, and performing alternator power generation by the induced voltage when the acquired induced voltage is equal to or higher than the preset voltage.

The rotational electric machine of the first aspect of the present invention includes the acquisition unit and the power generation control unit, The acquisition unit acquires the power supply voltage and the induced voltage of the rotational electric machine. The power generation control unit performs regenerative power generation when the acquired induced voltage is lower than a preset voltage equal to or lower than the acquired power supply voltage, and performs alternator power generation by the induced voltage when the acquired induced voltage is equal to or higher than the preset voltage. With this configuration, for example, it is possible to achieve the rotational electric machine capable of generating power even when the acquired induced voltage is equal to or higher than the acquired power supply voltage, that is, even when regenerative power generation cannot be performed.

The drive control system of the second aspect of the present invention includes the battery, the rotational electric machine connected to the battery, and the power generation control unit. The power generation control unit performs regenerative power generation by the kinetic energy of the vehicle when the acquired induced voltage is lower than a preset voltage equal to or lower than the acquired power supply voltage, and performs alternator power generation by the induced voltage when the acquired induced voltage is equal to or higher than the preset voltage. With this configuration, for example, it is possible to achieve a drive control system capable of generating power even when the acquire induced voltage is equal to or higher than the acquired power supply voltage, that is, even when the rotational electric machine cannot perform the regenerative power generation.

The power generation Method of the third aspect the present invention includes acquiring the power supply voltage of the battery and the induced voltage of the rotational electric machine, performing regenerative power generation when the acquired induced voltage is lower than a preset voltage equal to or lower than the acquired power supply voltage, and performing alternator power generation by the induced voltage when the acquired induced voltage is equal to or higher than the preset voltage. With this configuration, for example, it is possible to achieve a power generation method capable of generating power even when the acquired induced voltage is equal to or higher than the acquired power supply voltage, that is, even when regenerative power generation cannot be performed.

### BRIEF DESCRIPTION OF THE DRAWINGS

FIG. 1 is an explanatory diagram showing a configuration of a drive control system according to an embodiment of the present invention.

FIG. 2 is a first graph for illustrating control processing of the drive control system in FIG. 1.

FIG. 3 is a second graph for illustrating control processing of the drive control system in FIG. 1.

FIG. 4 is a third graph for illustrating control processing of the drive control system in FIG. 1.

FIG. 5 is a fourth graph for illustrating control processing of the drive control system in FIG. 1.

FIG. 6 is a graph for illustrating control processing during alternator power generation of drive control system in FIG. 1.

FIG. 7 is a flowchart for illustrating power generation processing of the drive control system in FIG. 1.

FIG. 8 is an explanatory diagram showing a configuration of a first modification of the drive control system in FIG. 1.

FIG. 9 is an explanatory diagram showing a configuration of a second modification of the drive control system in FIG. 1.

FIG. 10 is an explanatory diagram showing a configuration of a third modification of the drive control system in FIG. 1.

### DESCRIPTION OF THE PREFERRED EMBODIMENTS

Hereinafter, one embodiment of the present invention will be described in detail with reference to the drawings.

A drive control system and a rotational electric machine of the present invention may apply to a hybrid electric vehicle (HEV), an electric vehicle (EV), and other apparatuses including an electric motor as a configuration. In the present embodiment, a drive control system 100 and a rotational electric machine 1 for an electric vehicle (EV) will be described as an example.

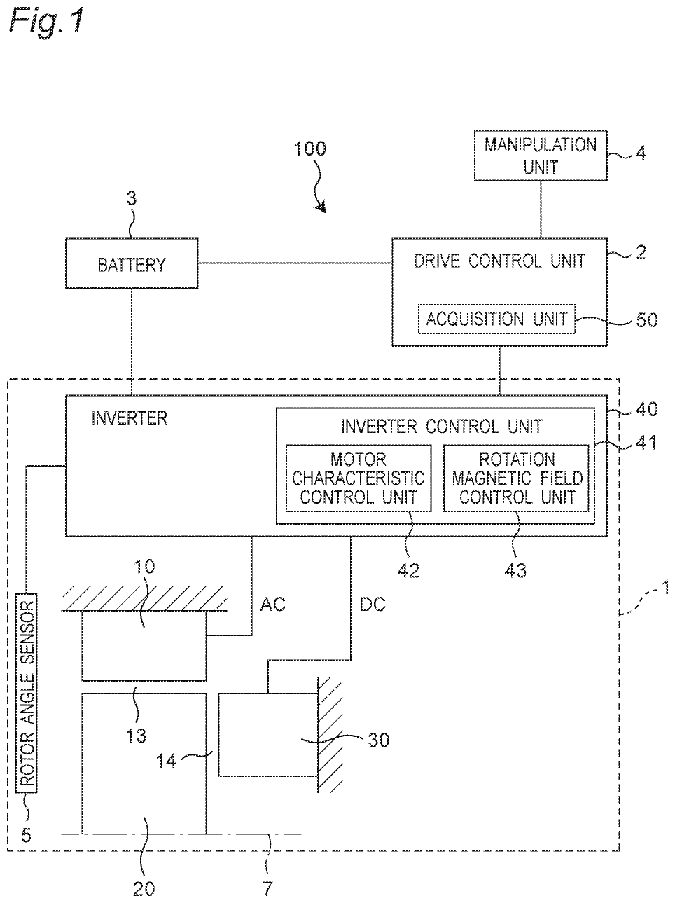

As shown in FIG. 1, the drive control system 100 includes a rotational electric machine a drive control unit 2, a battery 3, and a manipulation unit 4.

The rotational electric machine 1 is attached to a drive wheel (not shown) directly or indirectly via a transaxle or the like, and drives and rotates the drive wheel. As an example, as shown in FIG. 1, the rotational electric machine 1 includes a stator 10 that generates a rotating magnetic field in response to an alternating current, a rotor 20 that rotates in response to a rotating magnetic field, a field coil 30 that excites the rotor 20 in response to a direct current, and an inverter 40.

The stator 10 is disposed on an outer circumference centered on the rotating shaft 1 and is configured irrotationally around the rotating shaft 7. The rotor 20 is disposed on an inner circumference of the stator 10 and is configured rotatably around the rotating shaft 7. The field coil 30 is disposed on one side in a rotating shaft direction of the rotor 20 with respect to the rotor 20 and is configured irrotationally around the rotating shaft 7.

There is a first air gap 13 formed between the stator 10 and the rotor 20 to deliver magnetic flux between the stator 10 and the rotor 20. There is a second air gap 14 formed between the field coil 30 and the rotor 20 to deliver magnetic flux between the field coil 30 and the rotor 20. That is, the field coil 30 is arranged in parallel with the rotor 20 to be shifted in a shaft direction of the rotating shaft 7 with the second air gap 14 provided therebetween.

The rotor 20 has a permanent magnet (not shown) arranged inside the rotor 20. As the permanent magnet, a ferrite magnet, an SmCo magnet, an AlNiCo magnet, a neodymium bonded magnet, or the like may be used.

The inverter 40 converts the power supply voltage of the battery 3 and inputs a direct current and a multiple-phase alternating current into the stator 10 and the field coil 30. The inverter 40 includes an inverter control unit 41.

The inverter control unit 41 includes a CPU that performs calculations, a storage medium such as a ROM and a RAM that stores programs, data, or the like required for the control of the rotational electric machine 1, and an interface unit that performs data input and output with the outside as an example. The inverter control unit 41 includes a first acquisition unit 42 and a power generation control unit 43. The first acquisition unit 42 and the power generation control unit 43 have functions achieved in the inverter control unit 41 by the CPU of the inverter control unit 41 executing a predetermined program, for example.

The first acquisition unit 42 acquires a power supply voltage of the battery 3 and an induced voltage generated in the field coil 30 of the rotational electric machine 1. The induced voltage of the rotational electric machine 1 is measured by, for example, a voltage measuring apparatus (not shown) of the inverter 40.

The power generation control unit 43 decides whether to perform regenerative power generation or alternator power generation, based on the power supply voltage of the battery 3 acquired by the first acquisition unit 42 and a preset voltage being the induced voltage or less of the rotational electric machine 1. Specifically, the power generation control unit 43 performs regenerative power generation (in other words, regenerative power generation by vector control) by controlling the field coil 30 with an inverter when the acquired induced voltage is less than a preset voltage. The power generation control unit 43 performs alternator power generation (in other words, power generation using the induced voltage of the rotational electric machine 1) by controlling the field coil 30 with an alternator when the acquired induced voltage is equal to or higher than the preset voltage. The preset voltage is set, for example, via the interface unit.

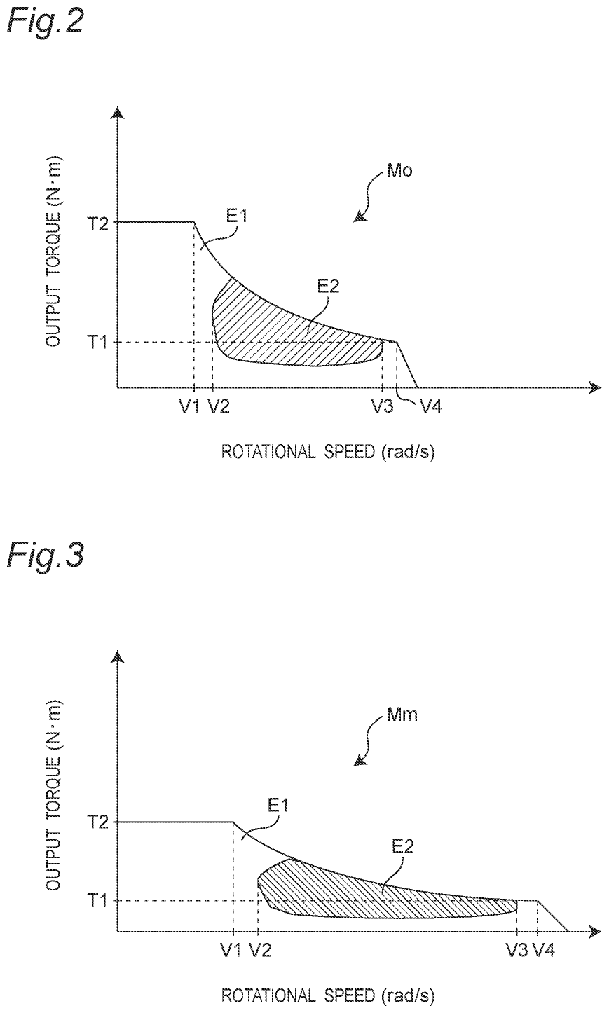

Here, FIGS. 2 to 5 show an example of motor characteristics achieved by controlling the direct current input to the field coil 30. The motor characteristic means an output characteristic regarding the relationship between torque, rotational speed, and current obtained when the rotational electric machine 1 is operated as A motor (that is, an electric motor). Hereinafter, “positive direct current” is defined as “direct current in the application direction for increasing the magnetic force by the permanent magnet provided in the rotor 20”, and “negative direct current” is defined as “direct current in the application direction for decreasing the magnetic force by the permanent magnet”.

The first motor characteristic Mo shown in FIG. 2 is a motor characteristic when direct current is controlled so that a value of the direct current, which energizes the field coil 30, becomes an intermediate value between an upper limit value and a lower limit value (that is, a set value). In the state of the motor characteristic Mo, the rotational electric machine 1 can change an operating point within the range E1 with control of the rotating magnetic field in the inverter control unit 41, that is, control of a frequency and an amplitude (that is, effective current) of a multiple-phase alternating current to be input into the rotational electric machine 1. An output torque can take a range from zero to a maximum value T2 while a rotational speed of the rotational electric machine 1 is relatively low from zero to V1. When the rotational speed is higher than V1, an upper limit value of the output torque gradually decreases from the maximum value T2. When the rotational speed is V4, the upper limit value of the output torque decreases to T1. When the rotational speed becomes higher than V4, the upper limit value of the output torque sharply decreases from T1 to almost zero.

An operating efficiency of the rotational electric machine 1 (that is, motor efficiency) differs depending on the operating point in the range E1, and distributes to draw a contour line in the range E1. For example, the range E2 having a predetermined high operating efficiency or more is limited to a partial region in the range E1, Normally, in the motor characteristic Mo of the rotational electric machine 1, higher operating efficiency can be obtained between the rotational speed V2 higher than the rotational speed V1 at which the upper limit value of the output torque starts to decrease and the rotational speed V3 lower than the rotational speed V4 at which the upper limit value of the output torque sharply decreases. The operating efficiency of the rotational electric machine 1 is represented by a ratio of a mechanical output (W) from the rotational electric machine 1 to an input power (W) into the rotational electric machine 1.

A motor characteristic Mm shown in FIG. 3 is a motor characteristic when the direct current is controlled so that the value of the direct current becomes a lower limit value (for example, a negative value), that is, a motor characteristic in a state where the magnetic force of the rotor 20 is reduced. The maximum value T2 of the output torque of the motor characteristic Mm is lower than the maximum value T2 of the motor characteristic Mo. The maximum rotational speed V4 of the motor characteristic Mm is higher than the maximum rotational speed V4 of the motor characteristic Mo. In the rotational electric machine 1, controlling the direct current, which energizes the field coil 30, to be negative allows an amount of magnetic flux by the permanent magnet to be equivalently reduced, and allows a torque constant and a induced voltage constant of the rotational electric machine 1 to be reduced. The maximum value T2 of the output torque of the rotational electric machine 1 of the motor characteristic Mm can be lower than the maximum value T2 of the motor characteristic Mo. The maximum rotational speed V4 of the motor characteristic Mm can be higher than the maximum rotational speed V4 of the motor characteristic Mo.

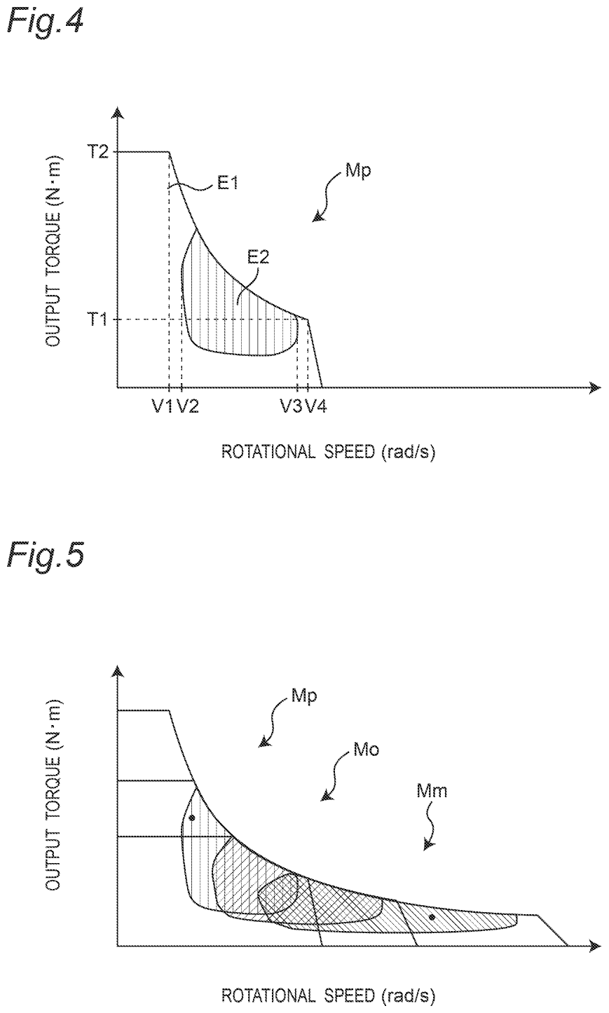

An motor characteristic Mp shown in FIG. 4 is a motor characteristic when the direct current is controlled so that the value of the direct current becomes an upper limit value (for example, a positive value), that is, a motor characteristic in a state where the magnetic force of the rotor 20 is increased. The maximum rotational speed V4 of the motor characteristic Mp is lower than the maximum rotational speed V4 of the motor characteristic Mo. However, the maximum value T2 of the output torque of the motor characteristic Mp is higher than the maximum value T2 of the motor characteristic Mo. In the rotational electric machine 1, controlling the direct current, which energizes the field coil 30, to be positive allows the amount of magnetic flux by the permanent magnet to be equivalent increased, and allows the torque constant and the induced voltage constant of the rotational electric machine 1 to be increased. The maximum rotational speed V4 of the rotational electric machine 1 of the motor characteristic Mp can be lower than the maximum rotational speed V4 of the motor characteristic Mo. However, the maximum value T2 of output torque of the motor characteristic Mp can be higher than the maximum value T2 of the motor characteristic Mo.

In the rotational electric machine 1, the motor characteristic can be varied between the waveform of the motor characteristic Mm shown in FIG. 3 and the waveform of the motor characteristic Mp shown in FIG. 4 by setting the value of the direct current energizing the field coil 30 to any value from the upper limit value to the lower limit value, and by controlling the direct current so that the value of the direct current becomes the set value. That is, as shown in FIG. 5, the equivalent motor characteristic Mx achieved by controlling the direct current is represented by a waveform in which the motor characteristics Mm, Mo, and Mp in FIGS. 2 to 4 are superimposed.

Within a range of the waveform of the motor characteristic shown in FIG. 5, the acquired induced voltage is less than the acquired power supply voltage, and the kinetic energy of the vehicle can perform regenerative power generation. In the high rotation region R which is outside the range of the waveform of the motor characteristic shown in FIG. 5 and in which the rotational speed is high, the acquired induced voltage is equal to or higher than the acquired power supply voltage, and regenerative power generation cannot be performed. However, the induced voltage of the rotational electric machine 1 can perform alternator power generation.

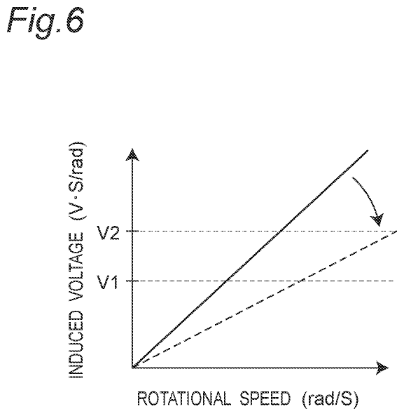

In alternator power generation, for example, as shown in FIG. 6, the power generation control unit 43 executes field weakening control so that the induced voltage is a preset lower limit value V1 or higher and an upper limit value V2 or lower. The lower limit value Vi is an induced voltage of the rotational electric machine 1 when switching from regenerative power generation to alternator power generation. For example, the lower limit value V1 is an induced voltage of the rotational electric machine 1 when the rotational speed is at the boundary between the waveform of the motor characteristic and the high rotation region R shown in FIG. 5. The upper limit value V2 is an induced voltage of the rotational electric machine 1 preset according to the performance of the battery 3.

An induced voltage y is calculated by, for example, the following Formula 1. In Formula 1, “x1” is the field coil current, “x2” is the rotational speed, and “a”and “b” are the Coefficients,

y=(ax1+b)*x2 Formula 1

The “ax1+b” in Formula 1 is an induced voltage constant, and it is shown that the induced voltage can be changed by “ax1”. The “h” is an induced voltage constant of the rotor 20 alone. When the rotor 20 does not have the permanent magnet, “b=0” may be set.

The drive control unit 2 controls the drive of the EV by outputting a manipulation command to each unit constituting the drive control system 100 based on the manipulation or the like accepted by the manipulation unit 4. The drive control unit 2 includes a second acquisition unit 50.

The second acquisition unit 50 acquires manipulation information from the manipulation unit 4 and acquires the rotational state of the rotational electric machine 1 (that is, the rotor 20) via the inverter 40 from the rotation angle or the like detected by a rotor angle sensor 5 disposed near the rotational electric machine 1.

The drive control unit 2 includes, as an example, a CPU that performs calculations and the like, a storage medium such as a ROM and a RAM that stores programs, data, or the like required for the control of the drive control system 100, and an interface unit that performs data input and output with the outside. The second acquisition unit 50 has a function achieved in the drive control unit 2 by the CPU of the drive control unit 2 executing a predetermined program, for example.

The battery 3 is electrically connected to the drive control unit 2 and the inverter 40 to supply electric power to the drive control unit 2 and the inverter 40. The power supply voltage of the battery 3 is preset according to the applicable vehicle design and the like.

The manipulation unit 4 is communicably connected to the drive control unit 2. The manipulation unit 4 receives a manipulation such as a driver's accelerator manipulation on the vehicle, and outputs information on the received manipulation to the drive control unit 2.

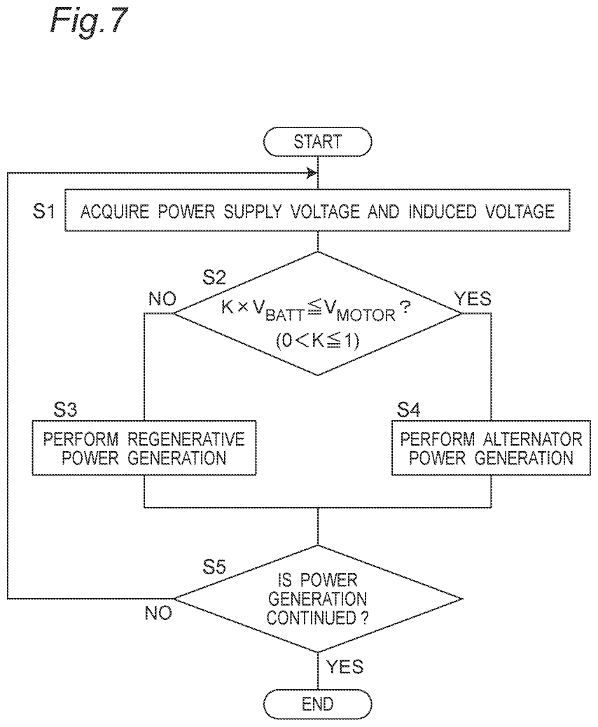

A power generation processing of the rotational electric machine 1 will be described with reference to FIG. 7, The processing described below is, for example, implemented by the CPU of the inverter control unit 41 executing a predetermined program.

When the vehicle is driven, for example, and the power generation processing starts, the first acquisition unit 42 acquires the power supply voltage of the battery 3 and the induced voltage of the rotational electric machine 1 (step S1) and, the power generation control unit 43 decides whether the acquired induced voltage (indicated by V_{MOTOR} in FIG. 7) is equal to or higher than a preset voltage (indicated by k×V_{BATT} (0<k≤1) in FIG. 7) equal to or lower than the acquired power supply voltage (step S2).

When the acquired induced voltage is lower than the preset voltage, the power generation control unit 43 performs regenerative power generation (step S3). When the acquired induced voltage is equal to or higher than the preset voltage, the power generation control unit 43 performs alternator power generation (step S4).

When regenerative power generation or alternator power generation is performed, it is decided whether to continue the power generation processing (step S5). When it is decided that the power generation processing is not continued, the power generation processing of the rotational electric machine 1 ends. When it is decided that the power generation processing is to be continued, the process returns to step S1, the power supply voltage of the battery 3 and the induced voltage of the rotational electric machine 1 are acquired again by the first acquisition unit 42, and it is decide whether the acquired induced voltage is equal to or higher than the preset voltage.

According to the rotational electric machine 1, the rotational electric machine 1 includes the first acquisition unit 42 and the power generation control Unit 43. The first acquisition unit 42 acquires the power supply voltage and the induced voltage of the rotational electric machine. The power generation control unit 43 performs regenerative power generation when the acquired induced voltage is lower than a preset voltage equal to or lower than the acquired power supply voltage and performs alternator power generation by the induced voltage when the acquired induced voltage is equal to or higher than the preset voltage. With this configuration, for example, it is possible to achieve the rotational electric machine 1 capable of generating power even when the acquired induced voltage is equal to or higher than the acquired power supply voltage, that is, even when regenerative power generation cannot be performed.

When performing alternator power generation, the power generation control unit 43 controls the direct current input to the field coil 30 to perform field weakening control so that the induced voltage becomes equal to or lower than the preset upper limit value V2. With this configuration, it is possible to more reliably achieve the rotational electric machine 1 capable of generating power even when regenerative power generation cannot be performed.

According to the drive control system 100, the drive control system 100 includes the battery 3, the rotational electric machine 1 connected to the battery 3, and the power generation control unit 43, The power generation control unit 43 performs regenerative power generation by the kinetic energy of the vehicle when the acquired induced voltage is lower than a preset voltage equal to or lower than the acquired power supply voltage, and performs alternator power generation by the induced voltage when the acquired induced voltage is equal to or higher than the preset voltage. With this configuration, for example, it is possible to achieve the drive control system 100 capable of generating power even when the acquired induced voltage is equal to or higher than the acquired power supply voltage, that is, even when regenerative power generation cannot be performed with the rotational electric machine,

According to a power generation method of the rotational electric machine 1, the power generation method includes acquiring power supply voltage of the battery 3 and the induced voltage of the rotational electric machine 1, performing regenerative power generation when the acquired induced voltage is lower than a preset voltage equal to or lower than the acquired power supply voltage, and performing alternator power generation by the induced voltage when the acquired induced voltage is equal to or higher than the preset voltage. With this configuration, for example, it is possible to achieve a power generation method capable of generating power even when the acquired induced voltage is equal to or hi her than the acquired power supply voltage, that is, even when regenerative power generation cannot be performed.

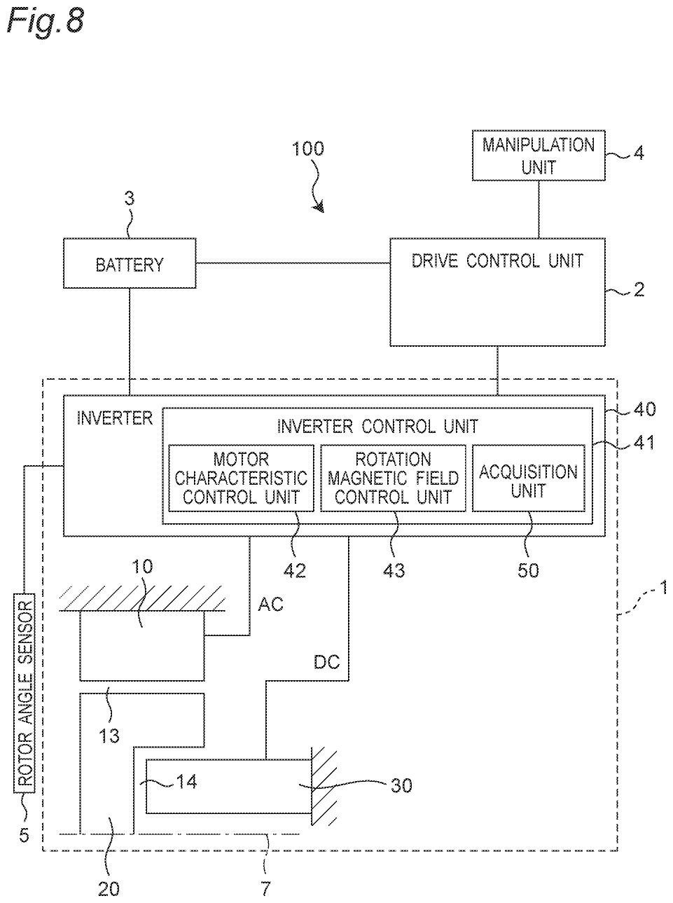

The rotational electric machine 1 can adopt not only the configuration shown in FIG. 1 but also, for example, the configuration shown in FIGS. 8 to 10.

In the drive control system 100 in FIG. 8, the field coil 30 is arranged on the inner circumference of the rotor 20 with respect to the rotor 20. The inverter control unit 41 includes the first acquisition unit 42, the power generation control unit 43, and the second acquisition unit 50.

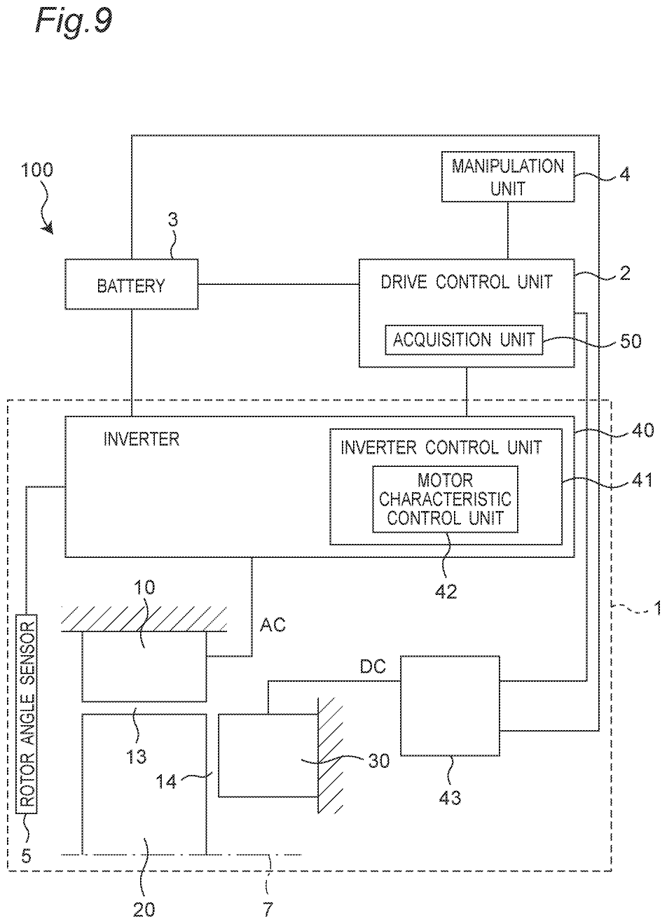

In the drive control system 100 in FIG. 9, the power generation control unit 43 is configured separately from the inverter 40, and the alternating current input to the stator 10 and the direct current input to the field coil 30 are connected to the battery 3 via electric paths of separate systems. As an example, the drive control system 100 in FIG. 9 includes an electrical path that connects the battery 3 and the stator 10 via the inverter 40 and an electric path that connects the battery 3 and the field coil 30 via the drive control unit 2 and the power generation control unit 43. With this configuration, even if an abnormality occurs in the inverter 40, the battery 3 can be protected from the induced voltage of the rotational electric machine 1.

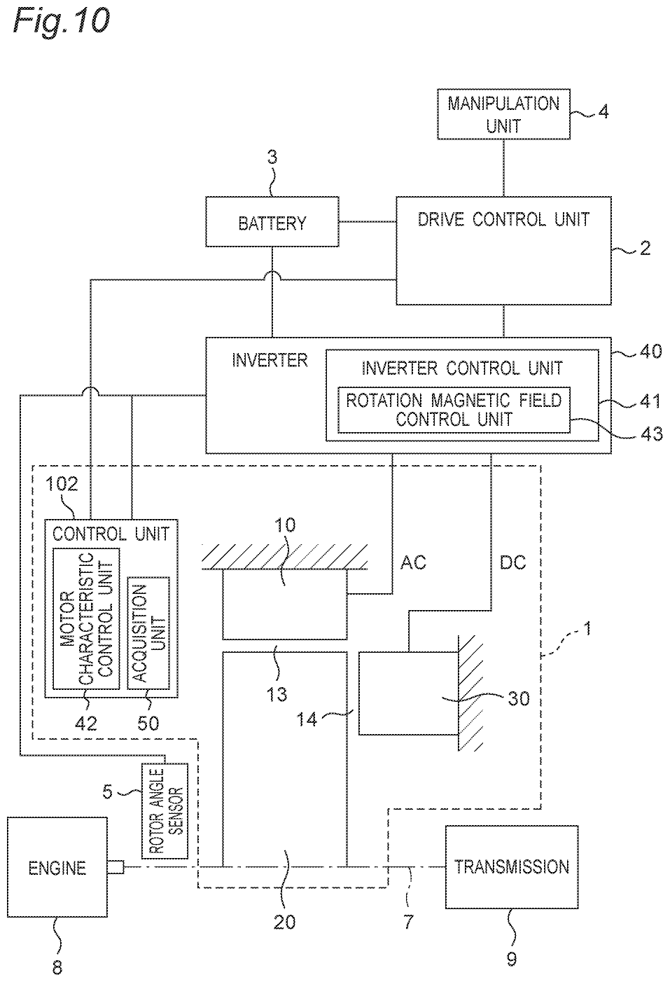

As an example, FIG. 10 shows the drive control system 100 and the rotational electric machine 1 in the case of being applied to a HEV (hybrid electric vehicle) with a combined use of a torque converter. In the drive control system 100 in FIG. 10, the rotational electric machine 1 is disposed between an engine 8 and a transmission 9 along the rotating shaft 7. The rotational electric machine 1 includes the stator 10, the rotor 20, the field coil 30, a control unit 102 including the first acquisition unit 42 and the second acquisition unit 50, and the inverter 40. The power generation control unit 43 is provided in the inverter control unit 41 of the inverter 40. In the drive control system 100 in FIG. 10, the rotor 20 can be integrally configured with the torque converter. In this case, for example, the rotor 20 is configured to at tach a magnetic pole member to be the rotor 20 to a casing of the torque converter.

Since the field coil 30 generates a magnetic force similar to a magnetic force of the permanent magnet, the rotor 20 may not include the permanent magnet. When the rotor 20 is not provided with the permanent magnet, the motor characteristic can be changed by changing the magnitude of the direct current flowing in one direction.

It should be noted that appropriately combining any embodiment or modification out of the various embodiments or modifications allows the effect of each embodiment or modification to be exhibited. In addition, a combination of the embodiments, a combination of the examples, or a combination of the embodiment and the example is possible, and a combination of the features out of different embodiments or the examples is also possible.

The present invention may be applied to, for example, a hybrid electric vehicle (HEV), an electric vehicle (EV), and an apparatus including an electric motor as a component.

### REFERENCE SIGNS LIST

1: rotational electric machine
2: drive control unit
3: battery
4: manipulation unit
5: rotor angle sensor
7: rotating shaft
10: stator
13: first air gap
14: second air gap
20: rotor
30: field coil
40: inverter
41: inverter control unit
42: first acquisition unit
43: power generation control unit
50: second acquisition unit
T1, T2: output torque
V1, V2, V3, V4: rotational speed
E1, E2: range
Mo, Mm, Mp: motor characteristic
R: region

1. A rotational electric machine connected to a battery, the rotational electric machine comprising:
a stator configured to generate a rotating magnetic field by an alternating current converted from a power supply voltage of the battery;
a rotor configured to rotate by the rotating magnetic field;
a field coil configured to excite the rotor by a direct current converted from a power supply voltage of the battery;
an acquisition unit configured to acquire the power supply voltage and an induced Voltage of the rotational electric machine; and
a power generation control unit configured to perform regenerative power generation when the induced voltage acquired is lower than a preset voltage equal to or lower than the power supply voltage acquired, and to perform alternator power generation by the induced voltage when the induced voltage acquired is equal to or higher than the preset voltage.

2. The rotational electric machine according to claim 1, wherein
when performing the alternator power generation, the power generation control unit controls the direct current input to the field coil to perform field weakening control so that the induced voltage becomes equal to or lower than a preset upper limit value.

3. The rotational electric machine according to claim 1, wherein
the alternating current input to the stator and the direct current input to the field coil are connected to the battery via electric paths of separate systems.

4. The rotational electric machine according to claim 2, wherein
the alternating current input to the stator and the direct current input to the field coil are connected to the battery via electric paths of separate systems.

5. A drive control system of a vehicle comprising:
a battery; and
a rotational electric machine connected to the battery, wherein
the rotational electric machine includes
a stator configured to generate a rotating magnetic field by an alternating current converted from a power supply voltage of the battery,
a rotor configured to rotate by the rotating magnetic field,
a field coil configured to excite the rotor by a direct current converted from a power supply voltage of the battery, and
an acquisition unit configured to acquire the power supply voltage and an induced voltage of the rotational electric machine, and
the drive control system further comprising a power generation control unit configured to perform regenerative power generation by kinetic energy of the vehicle when the induced voltage acquired is lower than a preset voltage equal to or lower than the power supply voltage acquired, and to perform alternator power generation by the induced voltage when the induced voltage acquired is equal to or higher than the preset voltage.

6. The drive control system according to claim 5, wherein
when performing the alternator power generation, the power generation control unit controls the direct current input to the field coil to perform field weakening control so that the induced voltage becomes equal to or lower than a preset upper limit value.

7. The drive control system according to claim 5, wherein
the alternating current input to the stator and the direct current input to the field coil are connected to the battery via electric paths of separate systems.

8. The drive control system according to claim 6, wherein
the alternating current input to the stator and the direct current input to the field coil are connected to the battery via electric paths of separate systems.

9. A power generation method of a rotational electric machine connected to a battery,
the rotational electric machine including
a stator configured to generate a rotating magnetic field by an alternating Current converted from a power supply voltage of the battery,
a rotor configured to rotate by the rotating magnetic field, and
a field coil configured to excite the rotor by a direct current converted from a power supply voltage of the battery,
the power generation method comprising:
acquiring a power supply voltage of the battery and an induced voltage of a rotational electric machine; and
performing regenerative power generation when the induced voltage acquired is lower than a preset voltage equal to or lower than the power supply voltage acquired, and performing alternator power generation by the induced voltage when the induced voltage acquired is equal to or higher than the preset voltage.
